(19) United States
(12) Patent Application Publication
(10) Pub. No.: US 2016/0368069 A1
(43) Pub. Date: Dec. 22, 2016

(54) MULTI-WIRE SAW

(71) Applicant: DISCO CORPORATION, Tokyo (JP)

(72) Inventors: Masayuki Matsubara, Tokyo (JP); Masaaki Suzuki, Tokyo (JP); Seiki Fuchiyama, Tokyo (JP)

(21) Appl. No.: 15/184,643

(22) Filed: Jun. 16, 2016

(30) Foreign Application Priority Data
Jun. 18, 2015 (JP) 2015-123115

(51) Int. Cl. B23H 7/10; B24B 27/06; B28D 5/04; B23H 7/06

(52) U.S. Cl. CPC B23H 7/104; B23H 7/06; B23H 7/105; B24B 27/0633; B28D 5/045

(57) ABSTRACT

Disclosed herein is a multi-wire saw including a wire, a set of guide rollers, an adjusting unit for adjusting tension of the wire wrapped around the guide rollers, a fixing base for fixing a workpiece to be cut by the wire wrapped around the guide rollers, and a moving mechanism for moving the workpiece fixed to the fixing base toward the wire. The adjusting unit includes an adjust roller around which the wire is wrapped, a rotational speed control section for controlling the rotational speed of the adjust roller, and a supply roller around which the wire is wrapped to be supplied to the adjust roller. The supply roller is provided with a wire shifting mechanism for suitably changing the axial position of the wire in the axial direction of the supply roller to thereby prevent the axial position of the wire wrapped around the adjust roller from being fixed.

### BACKGROUND OF THE INVENTION

Field of the Invention

The present invention relates to a multi-wire saw.

Description of the Related Art

A multi-wire saw using abrasive grains is known as cutting means for use in cutting a cylindrical ingot into wafers, for example (see Japanese Patent Laid-Open No. 1997-94755). Also known is a multi-wire electrical discharge processing apparatus for performing electrical discharge machining by using a wire saw (see Japanese Patent Laid-Open No. 2011-140088).

### SUMMARY OF THE INVENTION

Some kind of multi-wire saw includes an adjust roller for adjusting tension of a wire to be guided. Since the tension of the wire is adjusted by the adjust roller, a strong contact force acts between the wire and the adjust roller. Accordingly, there is a possibility of mutual adverse effects on the wire and the adjust roller.

It is therefore an object of the present invention to provide a multi-wire saw which can reduce the mutual adverse effects on the wire and the adjust roller.

In accordance with an aspect of the present invention, there is provided a multi-wire saw including a wire; a set of guide rollers having parallel rotation axes, the wire being wrapped around the guide rollers by a plurality of turns; adjusting means for adjusting tension of the wire wrapped around the guide rollers; a fixing base for fixing a workpiece to be cut by the wire wrapped around the guide rollers; and moving means for moving the workpiece fixed to the fixing base toward the wire; the adjusting means including an adjust roller around which the wire is wrapped, a rotational speed control section for controlling the rotational speed of the adjust roller, and a supply roller around which the wire is wrapped to be supplied to the adjust roller, the supply roller being provided with wire shifting means for suitably changing the axial position of the wire in the axial direction of the supply roller to thereby prevent the axial position of the wire wrapped around the adjust roller from being fixed.

Preferably, the wire shifting means includes a guide groove formed on the supply roller for guiding the wire; at least part of the guide groove being inclined with respect to the axial direction of the supply roller.

In the multi-wire saw of the present invention, the axial position of the wire kept in contact with the adjust roller can be shifted in the axial direction of the adjust roller. Accordingly, it is possible to prevent the wire from continuing to come into contact with part of the adjust roller and causing the concentration of load on the adjust roller. As a result, mutual adverse effects on the adjust roller and the wire can be reduced.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a schematic view showing the configuration of a multi-wire electrical discharge processing apparatus according to a preferred embodiment of the present invention;

FIG. 2 is an enlarged schematic perspective view of an essential part of the multi-wire electrical discharge processing apparatus shown in FIG. 1 and a workpiece to be processed by the processing apparatus;

FIG. 3 is a schematic view showing the configuration of a tension adjusting unit according to this preferred embodiment;

FIG. 4 is a schematic view for illustrating the operation of the tension adjusting unit shown in FIG. 3;

FIG. 5 is a schematic view showing the configuration of a tension adjusting unit according to a modification of this preferred embodiment; and

FIG. 6 is a schematic view for illustrating the operation of the tension adjusting unit shown in FIG. 5.

### DETAILED DESCRIPTION OF THE PREFERRED EMBODIMENT

A preferred embodiment of the present invention will now be described in detail with reference to the drawings. The present invention is not limited to this preferred embodiment. Further, the components used in this preferred embodiment may include those that can be easily assumed by persons skilled in the art or substantially the same elements as those known in the art. Further, the configurations described below may be suitably combined. Further, the configurations may be variously omitted, replaced, or changed without departing from the scope of the present invention.

### Preferred Embodiment

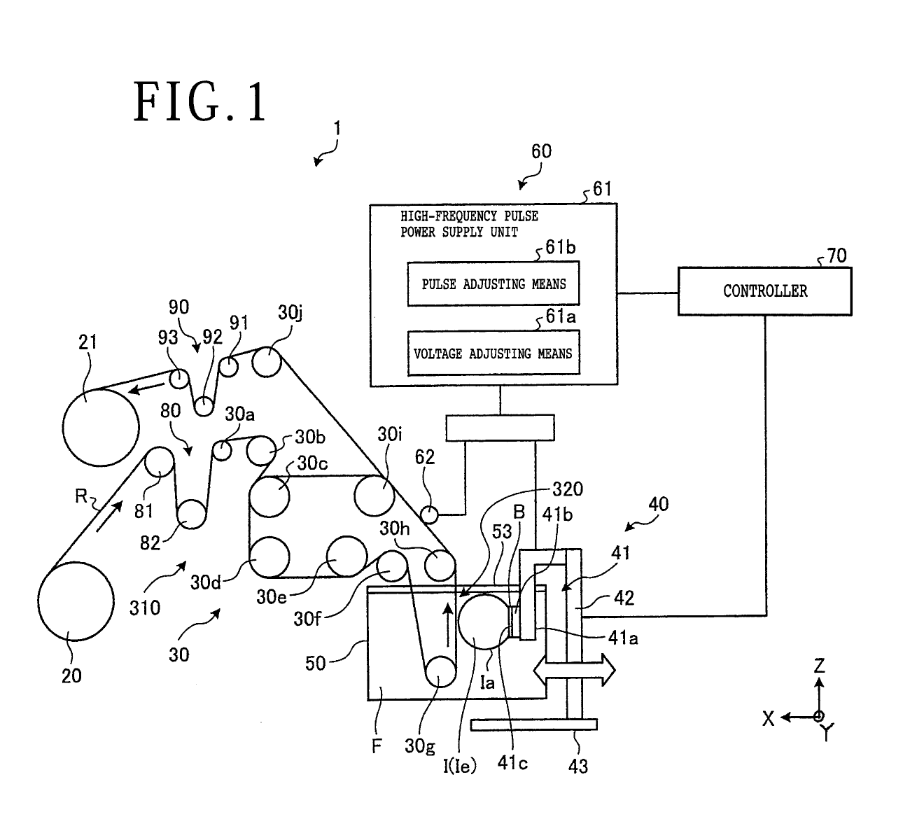

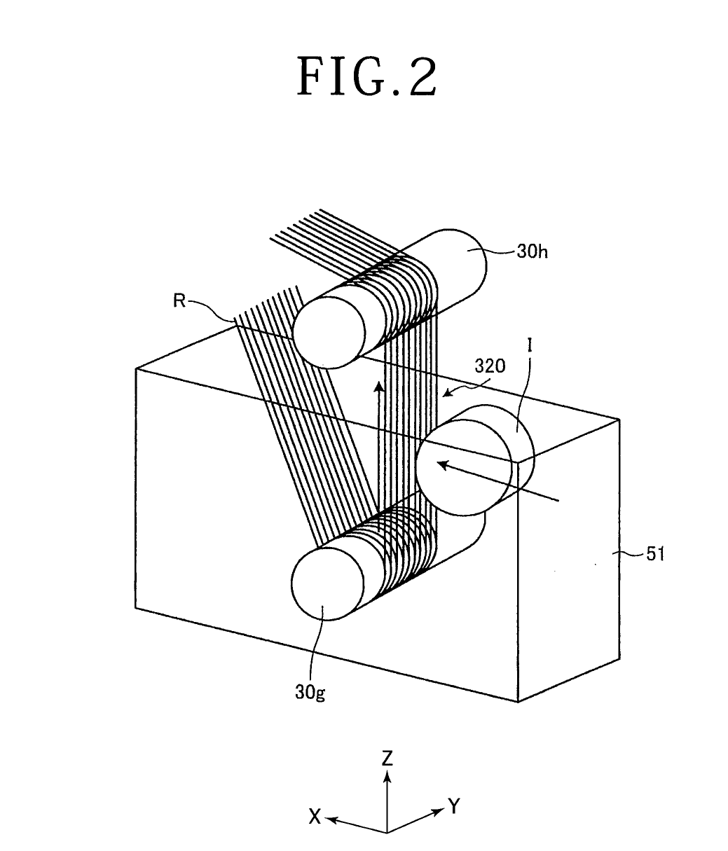

There will now be described a multi-wire electrical discharge processing apparatus 1 according to a preferred embodiment of the present invention. FIG. 1 is a schematic view showing the configuration of the multi-wire electrical discharge processing apparatus 1. FIG. 2 is an enlarged schematic perspective view of an essential part of the multi-wire electrical discharge processing apparatus 1 and a workpiece to be processed thereby. As shown in FIG. 1, the multi-wire electrical discharge processing apparatus 1 is an apparatus for performing electrical discharge machining to an ingot I by using wire R, and the multi-wire electrical discharge processing apparatus 1 includes a supply bobbin 20, a take-up bobbin 21, a guide roller unit (a set of guide rollers) 30, a first tension adjusting unit 80, and a second tension adjusting unit 90.

A given amount of unused wire R is wound around the supply bobbin 20. The wire R has a circular cross section, and includes a core portion and a cover portion for covering the circumferential surface of the core portion. The core portion is formed of high-purity steel. For example, a piano wire is used as the core portion. The cover portion is formed of a material having low electrical resistance, which is easier to discharge than the core portion. Examples of the material of the cover portion include brass, tungsten, and molybdenum. The diameter of the wire R is set to 100 μm to 140 μm, for example. However, the diameter of the wire R is not limited to 100 μm to 140 μm in the present invention, but it may be set to 100 μm to 200 μm, for example. Further, while the wire R includes the core portion of high-purity steel and the cover portion of brass, tungsten, or molybdenum in this preferred embodiment, the wire R may be formed only of brass. Further, while the wire R has a circular cross section in this preferred embodiment, the cross section of the wire R may have any shapes other than a circular shape. For example, the cross section of the wire R may have an elliptical shape or a polygonal shape.

The supply bobbin 20 functions to supply the wire R toward the guide roller unit 30. The first tension adjusting unit 80 is located between the supply bobbin 20 and the guide roller unit 30. The wire R supplied from the supply bobbin 20 is wrapped around a plurality of rollers constituting the first tension adjusting unit 80. The configuration of the first tension adjusting unit 80 will be hereinafter described. The guide roller unit 30 is provided in the vicinity of the supply bobbin 20 and functions to guide the wire R supplied from the supply bobbin 20. The guide roller unit 30 includes a plurality of guide rollers 30a to 30j. These guide rollers 30a to 30j are cylindrical and they are spaced from each other in the running direction of the wire R.

The guide rollers 30a and 30b are provided in the vicinity of the supply bobbin 20. The wire R supplied from the supply bobbin 20 and passed through the first tension adjusting unit 80 is wrapped around the guide rollers 30a and 30b and then fed toward the guide rollers 30c to 30i.

The guide rollers 30c to 30i constitute a parallel wire unit 310, and these guide rollers 30c to 30i are arranged so as to support the wire R in the form of a ring. For example, the guide rollers 30c, 30d, 30e, 30g, 30h, and 30i are arranged so as to support the inside of the ring of the wire R, and the guide roller 30f is arranged so as to support the outside of the ring of the wire R. As shown in FIG. 2, the wire R fed by the guide rollers 30a and 30b is wrapped around the guide rollers 30c to 30i constituting the parallel wire unit 310 by a plurality of turns so as to define a given spacing in the axial direction (Y direction) of the guide rollers 30c to 30i. That is, in the parallel wire unit 310, the wire R is wrapped around the guide rollers 30c to 30i in the condition that a plurality of parallel portions of the wire R are arranged at given intervals in the axial direction of the guide rollers 30c to 30i. For example, the wire R is wrapped around the guide rollers 30c to 30i by eight turns in the condition that eight parallel portions of the wire R are arranged at intervals of 0.5 mm to several millimeters in the axial direction of the guide rollers 30c to 30i.

The Y direction is defined as the direction perpendicular to the sheet plane of FIG. 1, i.e., the axial direction of the guide rollers 30a to 30j. The X direction shown by an arrow X in FIG. 1 is defined as the direction perpendicular to the Y direction in a horizontal plane. The Z direction shown by an arrow Z in FIG. 1 is defined as the direction perpendicular to both the X direction and the Y direction. In this preferred embodiment, the Z direction is defined as a vertical direction.

In the parallel wire unit 310, the wire R fed by the guide roller 30b is wrapped around the guide roller 30c and then fed to the guide roller 30d by the guide roller 30c. The wire R fed by the guide roller 30c is wrapped around the guide roller 30d and then fed to the guide roller 30e by the guide roller 30d. The wire R fed by the guide roller 30d is wrapped around the guide roller 30e and then fed to the guide roller 30f by the guide roller 30e. The wire R fed by the guide roller 30e is wrapped around the guide roller 30f and then fed to the guide roller 30g by the guide roller 30f. The wire R fed by the guide roller 30f is wrapped around the guide roller 30g and then fed to the guide roller 30h by the guide roller 30g. The wire R fed by the guide roller 30g is wrapped around the guide roller 30h and then fed to the guide roller 30i by the guide roller 30h. The wire R fed by the guide roller 30h is wrapped around the guide roller 30i and then fed to the guide roller 30c by the guide roller 30i. Accordingly, the wire R is wrapped around the guide rollers 30c to 30i constituting the parallel wire unit 310 by one turn. Thereafter, the wire R is similarly wrapped around the guide rollers 30c to 30i by the remaining seven turns in the condition that the totally eight parallel portions of the wire R are arranged at intervals of 0.5 mm to several millimeters in the axial direction of the guide rollers 30c to 30i. After wrapping the wire R around the guide rollers 30c to 30i by eight turns as mentioned above, the wire R is fed from the guide roller 30i to the guide roller 30j.

The guide roller 30j is located in the vicinity of the take-up bobbin 21. The wire R fed from the parallel wire unit 310 is wrapped around the guide roller 30j and then fed to the take-up bobbin 21. The used wire R fed from the guide roller 30j is taken up to be recovered by the take-up bobbin 21. The second tension adjusting unit 90 is located between the guide roller unit 30 and the take-up bobbin 21. The wire R fed from the guide roller 30j is wrapped around a plurality of rollers constituting the second tension adjusting unit 90. The configuration of the second tension adjusting unit 90 will be hereinafter described.

The supply bobbin 20, the take-up bobbin 21, and the guide rollers 30a to 30j are rotationally driven by motors (not shown). All of the guide rollers 30a to 30j are not required to be motor-driven. For example, the guide rollers 30a, 30b, and 30j not constituting the parallel wire unit 310 may be configured as driven rollers. The running speed of the wire R wrapped around the guide rollers 30a to 30j is set to 0.5 m/second to 1 m/second, for example.

In the parallel wire unit 310, the wire R is stretched under a given tension in the Z direction by the guide rollers 30g and 30h forming a pair. The wire R stretched by the guide rollers 30g and 30h constitutes a cutting wire unit 320 for slicing the ingot I into wafers. This wire R constituting the cutting wire unit 320 runs upward in the Z direction.

The ingot I is cylindrical in shape and it is sliced into disk-shaped wafers having thicknesses corresponding to the intervals of the parallel portions of the wire R constituting the cutting wire unit 320. The ingot I is formed of a conductive material such as SiC (silicon carbide), single crystal diamond, silicon, and GaN (gallium nitride).

A supporting mechanism 40 for supporting the ingot I is provided in the vicinity of the cutting wire unit 320. The supporting mechanism 40 includes a base unit 41, a support column 42, and driving means 43. The base unit 41 functions to fix the ingot I. The base unit 41 includes a base 41a and a platelike substrate 41b fixed to the base 41a. The substrate 41b has a front surface 41c, and the ingot I has a circumferential surface (cylindrical surface) Ia. The circumferential surface Ia of the ingot I is fixed through a conductive adhesive B to the front surface 41c of the substrate 41b. The ingot I has an end surface Ie, and the ingot I is fixed to the substrate 41b of the base unit 41 so that the end surface Ie of the ingot I becomes substantially parallel to the Z direction as the running direction of the wire R in the cutting wire unit 320.

The support column 42 is formed like a rod and extends in the Z direction. The base unit 41 is fixed to one end of the support column 42, and the driving means 43 is fixed to the other end of the support column 42. The driving means 43 functions to relatively move the ingot I and the wire R in the X direction. For example, the driving means 43 has a ball screw (not shown) extending in the X direction and a drive source such as a pulse motor (not shown) for rotating the ball screw. A nut (not shown) is threadedly engaged with the ball screw, and the support column 42 is fixed to the nut. Accordingly, when the ball screw is rotated by the drive source, the support column 42 is moved in the X direction, so that the base unit 41 fixed to the support column 42 is moved in the X direction and the ingot I fixed to the base unit 41 is accordingly moved in the X direction, thereby making the wire R in the cutting wire unit 320 relatively cut into the ingot I.

The multi-wire electrical discharge machining is performed in a working fluid F such as water and oil as a dielectric. The working fluid F is stored in a working tank 50. The cutting wire unit 320 is immersed in the working tank 50 storing the working fluid F. That is, the wire R constituting the cutting wire unit 320 immersed in the working fluid F functions to cut the ingot I in the working tank 50.

The working tank 50 has an upper opening 53. The base unit 41 is inserted into the working tank 50 from the upper opening 53. The base unit 41 is movable back and forth in the X direction with respect to the working tank 50. The wire R fed from the guide roller 30f is allowed to enter the working tank 50 from the upper opening 53. The wire R allowed to enter the working tank 50 is then fed by the guide roller 30g provided in the working tank 50 to run upward and come out of the working tank 50 from the upper opening 53.

The multi-wire electrical discharge processing apparatus 1 includes an electrical power supplying mechanism 60 for supplying an electrical power to the wire R and the ingot I. The electrical power supplying mechanism 60 includes a high-frequency pulse power supply unit 61, a wire electrode 62, and a base electrode (not shown).

The high-frequency pulse power supply unit 61 functions to supply a high-frequency pulse power to both the wire R and the ingot I fixed to the base unit 41. For example, the high-frequency pulse power supply unit 61 includes voltage adjusting means 61a for adjusting the voltage of the high-frequency pulse power and pulse adjusting means 61b for adjusting the frequency of the high-frequency pulse power to a predetermined frequency. The high-frequency pulse power supply unit 61 is connected to the wire electrode 62, so that the high-frequency pulse power is supplied through the wire electrode 62 to the wire R. The wire electrode 62 is formed like a rod, and it is kept in contact with the wire R stretched between the guide roller 30h and the guide roller 30i. The high-frequency pulse power supply unit 61 is connected to the base electrode fixed to the base unit 41, so that the high-frequency pulse power is supplied through the base unit 41 to the ingot I.

When the high-frequency pulse power is supplied from the high-frequency pulse power supply unit 61 to thereby apply a voltage between the two electrodes for the wire R and the ingot I, the wire R operates to conduct electrical discharge to the ingot I opposed to the wire R. For example, when the spacing between the ingot I and the wire R electrically insulated in the working fluid F becomes several tens of micrometers, the electrical insulation between the ingot I and the wire R breaks down to produce an electrical discharge therebetween. Due to this electrical discharge, the ingot I is heated to be melted. Further, the working fluid F rapidly rises in temperature to cause vaporization, so that the volume of the working fluid F is expanded to cause scattering of a melted part of the ingot I. In this manner, a voltage is applied between the two electrodes for the wire R and the ingot I to thereby intermittently perform the processing of melting the ingot I and scattering the melted part, thus carrying out the electrical discharge machining of the ingot I.

The multi-wire electrical discharge processing apparatus 1 further includes a controller 70 for controlling all of the supply bobbin 20, the take-up bobbin 21, the guide rollers 30a to 30j, the driving means 43, and the high-frequency pulse power supply unit 61. The controller 70 functions to output motor driving signals to the supply bobbin 20, the take-up bobbin 21, and the guide rollers 30a to 30j, thereby controlling the supply and take-up of the wire R and the guide of the wire R. Further, the controller 70 functions to output a motor driving signal to the driving means 43, thereby controlling the movement of the ingot I with respect to the wire R. Further, the controller 70 functions to output a control signal to the high-frequency pulse power supply unit 61, thereby controlling the output time of the high-frequency pulse power, for example.

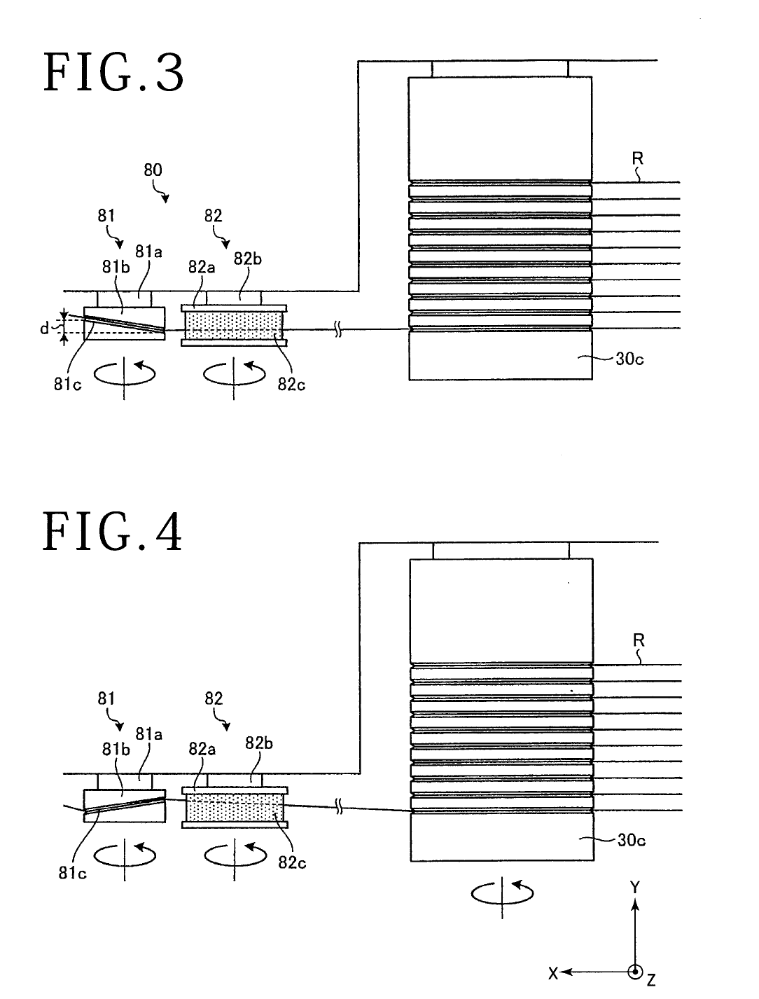

The first and second tension adjusting units 80 and 90 will now be described in detail. FIG. 3 is a schematic view showing the configuration of the first tension adjusting unit 80, and FIG. 4 is a schematic view for illustrating the operation of the first tension adjusting unit 80. Although drawings for the second tension adjusting unit 90 as corresponding to FIGS. 3 and 4 are not included, the configuration and operation of the second tension adjusting unit 90 are similar to those of the first tension adjusting unit 80. In FIGS. 3 and 4, the guide rollers 30a and 30b are omitted.

As shown in FIG. 1, the first tension adjusting unit 80 is located between the supply bobbin 20 and the guide roller 30a. The first tension adjusting unit 80 has a supply roller unit 81 and an adjust roller unit 82. The supply roller unit 81 and the adjust roller unit 82 are arranged in this order in the running direction of the wire R. That is, the adjust roller unit 82 is located downstream of the supply roller unit 81 in the running direction of the wire R.

The wire R supplied from the supply bobbin 20 is further supplied to the adjust roller unit 82 by the supply roller unit 81. As shown in FIG. 2, the supply roller unit 81 has a rotating shaft 81a and a supply roller 81b. The rotating shaft 81a is rotatably supported to a housing or the like. The wire R is wrapped around the supply roller 81b. The supply roller 81b is fixed to the rotating shaft 81a, so that the supply roller 81b is rotatable with the rotating shaft 81a about the axis thereof. Accordingly, the supply roller 81b is driven by the movement of the wire R wrapped around the supply roller 81b. A guide groove 81c is formed on the outer circumferential surface of the supply roller 81b along the rotational direction thereof, wherein the wire R is engaged with the guide groove 81c and guided thereby. The guide groove 81c is formed over the entire circumference on the outer circumferential surface of the supply roller 81b so as to form a circular ring. When the guide groove 81c is moved in the rotational direction of the supply roller 81b, the axial position of the guide groove 81c in the axial direction of the supply roller 81b, i.e., the rotating shaft 81a is changed. That is, the guide groove 81c is displaced in the axial direction of the supply roller 81b during the rotation of the supply roller 81b. In other words, the guide groove 81c is inclined with respect to the axial direction of the supply roller 81b. More specifically, one end of the guide groove 81c and the other end of the guide groove 81c as viewed in FIG. 3 are shifted from each other by a distance d in the axial direction of the rotating shaft 81a. For example, this distance d is set to 6 mm. Part of the guide groove 81c may be perpendicular to the axial direction of the rotating shaft 81a.

As shown in FIG. 3, the adjust roller unit 82 has an adjust roller 82a and a rotational speed control section 82b. The outer circumferential surface of the adjust roller 82a is provided with slip preventing means 82c. The slip preventing means 82c is a member for improving a frictional force to the wire R. That is, the slip preventing means 82c is formed of a material having high frictional resistance, such as silicone resin. The rotational speed control section 82b is connected to the adjust roller 82a and functions to control the rotational speed of the adjust roller 82a.

As shown in FIG. 1, the second tension adjusting unit 90 is located between the guide roller 30j and the take-up bobbin 21. The second tension adjusting unit 90 has a supply roller unit 91, an adjust roller unit 92, and a driven roller 93. The supply roller unit 91, the adjust roller unit 92, and the driven roller 93 are arranged in this order in the running direction of the wire R. That is, the adjust roller unit 92 is located downstream of the supply roller unit 91 in the running direction of the wire R, and the driven roller 93 is located downstream of the adjust roller unit 92 in the running direction of the wire R. The supply roller unit 91 is similar in function to the supply roller unit 81, and the adjust roller unit 92 is similar in function to the adjust roller unit 82. That is, the supply roller unit 91 functions to supply the wire R to the adjust roller unit 92. The adjust roller unit 92 has an adjust roller (not shown) similar to the adjust roller 82a and a rotational speed control section (not shown) similar to the rotational speed control section 82b. The rotational speed control section of the adjust roller unit 92 functions to control the rotational speed of the adjust roller, thereby adjusting the tension of the wire R wrapped around the guide rollers 30a to 30j constituting the guide roller unit 30 located upstream of the second tension adjusting unit 90. The driven roller 93 is located between the adjust roller unit 92 and the take-up bobbin 21, and the wire R is wrapped around the driven roller 93. That is, the driven roller 93 is driven by the movement of the wire R wrapped around the driven roller 93.

The operation of the multi-wire electrical discharge processing apparatus 1 will now be described. First, the ingot I is fixed to the base unit 41 by an operator, and the working fluid F is stored into the working tank 50 by the operator. Further, working information is recorded into the controller 70 by the operator. When receiving an instruction of starting a working operation, the multi-wire electrical discharge processing apparatus 1 starts the working operation. In performing the working operation, the controller 70 controls the high-frequency pulse power supply unit 61 to supply a high-frequency pulse power to the wire R and the ingot I. Further, the controller 70 operates the supply bobbin 20 to supply the wire R from the supply bobbin 20 and operates the guide roller unit 30 to guide the wire R in running the wire R at a given speed.

The wire R is fed from the guide roller 30b to the parallel wire unit 310. The wire R fed to the parallel wire unit 310 performs electrical discharge machining to the ingot I at the cutting wire unit 320. For example, the controller 70 controls the driving means 43 to move the ingot I toward the wire R in the cutting wire unit 320. Thereafter, a voltage is applied between the two electrodes for the wire R and the ingot I to perform electrical discharge machining to the ingot I, thereby forming a plurality of processed grooves on the ingot I. For example, when the ingot I is moved close to the wire R, electrical discharge occurs between the ingot I and the wire R, so that the ingot I is melted and its melted part is scattered. This processing is intermittently performed to thereby form the processed grooves on the ingot I.

Further, although not shown, measuring means for measuring the tension of the wire R is provided in the path of the wire R running in the guide roller unit 30. Then, the operation of the first and second tension adjusting units 80 and 90 is controlled according to the result of measurement by the measuring means, thereby adjusting the tension of the wire R. The measuring means may be configured by providing a roller around which the wire R is wrapped and measuring a force applied to the roller.

In the first tension adjusting unit 80, the rotational speed of the adjust roller 82a of the adjust roller unit 82 is adjusted by the rotational speed control section 82b of the adjust roller unit 82. In the second tension adjusting unit 90, the rotational speed of the adjust roller (not shown) of the adjust roller unit 92 is adjusted by the rotational speed control section (not shown) of the adjust roller unit 92. Accordingly, the tension of the wire R between the adjust roller unit 82 and the adjust roller unit 92 can be adjusted. As a result, the tension of the wire R in the cutting wire unit 320 opposed to the ingot I can be adjusted. For example, when the rotational speed of the adjust roller 82a of the adjust roller unit 82 is increased, the tension of the wire R can be decreased, whereas when the rotational speed of the adjust roller 82a is decreased, the tension of the wire R can be increased. In contrast, when the rotational speed of the adjust roller (not shown) of the adjust roller unit 92 is increased, the tension of the wire R can be increased, whereas when the rotational speed of the adjust roller is decreased, the tension of the wire R can be decreased. Accordingly, even in the case that foreign matter is caught between the wire R and the guide rollers 30a to 30j of the guide roller unit 30 or the shape of the outer surface of the wire R changes to cause a change in gripped condition of the wire R by the guide roller unit 30, the tension of the wire R in the guide roller unit 30 can be adjusted by suitably operating the adjust roller units 82 and 92. Accordingly, a change in tension of the wire R can be suppressed to thereby suppress vibrations and breakage of the wire R.

In the first tension adjusting unit 80, the wire R supplied from the supply bobbin 20 is wrapped around the supply roller 81b. The wire R wrapped around the supply roller 81b is guided by the guide groove 81c. The wire R passed through the supply roller 81b is wrapped around the adjust roller 82a in the condition where the wire R is in contact with the slip preventing means 82c. Accordingly, as shown in FIGS. 3 and 4, the axial position of the guide groove 81c in the axial direction of the rotating shaft 81a changes according to a rotational position of the supply roller 81b, so that the axial position of the wire R passed through the supply roller 81b can be changed periodically. Accordingly, the axial position of the wire R reaching the adjust roller 82a can be changed periodically, so that the axial position of the wire R kept in contact with the adjust roller 82a through the slip preventing means 82c can be changed periodically. The diameter of the supply roller 81b is different from the diameter of the adjust roller 82a.

In the multi-wire electrical discharge processing apparatus 1 according to this preferred embodiment, the guide groove 81c formed on the supply roller 81b functions as wire shifting means for suitably changing the axial position of the wire R in the axial direction of the supply roller 81b to thereby prevent that the axial position of the wire R wrapped around the adjust roller 82a may be fixed. Since the axial position of the guide groove 81c in the axial direction of the supply roller 81b changes with the rotation of the supply roller 81b, the axial position of the wire R kept in contact with the adjust roller 82a can be shifted in the axial direction of the adjust roller 82a. Accordingly, it is possible to prevent the wire R from continuing to come into contact with part of the adjust roller 82a and causing the concentration of load on the adjust roller 82a. As a result, mutual adverse effects on the adjust roller 82a and the wire R can be reduced. For example, damage to the surface of the slip preventing means 82c can be suppressed. Further, since damage to the surface of the slip preventing means 82c can be suppressed, the contact between the wire R and the damaged slip preventing means 82c can be suppressed to thereby suppress damage to the wire R. Although not especially described in detail, the operation of the supply roller unit 91 and the adjust roller unit 92 in the second tension adjusting unit 90 is similar to that in the first tension adjusting unit 80 mentioned above.

Further, the wire shifting means in this preferred embodiment is provided by the guide groove 81c formed on the supply roller 81b rotationally driven by the movement (running) of the wire R, wherein the axial position of the guide groove 81c in the axial direction of the supply roller 81b changes with the rotation of the supply roller 81b. That is, the axial position of the wire R wrapped around the supply roller 81b can be changed (shifted) in the axial direction of the supply roller 81b without supplying power.

While the first and second tension adjusting units 80 and 90 are provided upstream and downstream of the guide roller unit 30, respectively, in this preferred embodiment, any one of the first and second tension adjusting units 80 and 90 may be omitted.

### (Modification)

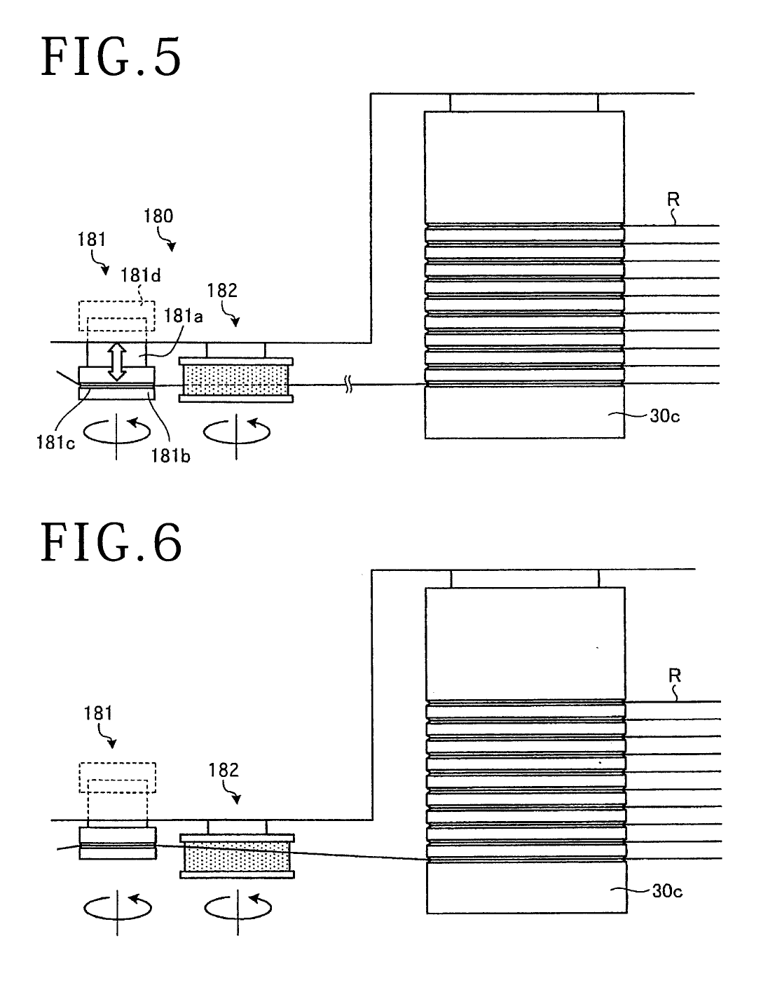

FIG. 5 is a schematic view showing the configuration of a tension adjusting unit 180 according to a modification of the above preferred embodiment, and FIG. 6 is a schematic view for illustrating the operation of the tension adjusting unit 180. As shown in FIGS. 5 and 6, the tension adjusting unit 180 has a supply roller unit 181 and an adjust roller unit 182. The adjust roller unit 182 in the tension adjusting unit 180 is similar in configuration to the adjust roller unit 82 in the first tension adjusting unit 80. The supply roller unit 181 and the adjust roller unit 182 are arranged in this order in the running direction of the wire R. That is, the adjust roller unit 182 is located downstream of the supply roller unit 181 in the running direction of the wire R.

The wire R supplied from the supply bobbin 20 (see FIG. 1) is further supplied to the adjust roller unit 182 by the supply roller unit 181. As shown in FIG. 5, the supply roller unit 181 has a rotating shaft 181a, a supply roller 181b, and a rotating shaft moving mechanism 181d. The rotating shaft 181a is rotatably supported to a housing or the like. The wire R is wrapped around the supply roller 181b. The supply roller 181b is fixed to the rotating shaft 181a, so that the supply roller 181b is rotatable with the rotating shaft 181a about the axis thereof. A guide groove 181c is formed on the outer circumferential surface of the supply roller 181b along the rotational direction thereof, wherein the wire R is engaged with the guide groove 181c and guided thereby. The guide groove 181c is formed over the entire circumference on the outer circumferential surface of the supply roller 181b so as to form a circular ring. Regardless of the movement of the guide groove 181c in the rotational direction of the supply roller 181b, the orientation of the guide groove 181c is not changed. That is, the guide groove 181c extends in a direction perpendicular to the axial direction of the supply roller 181b. The rotating shaft moving mechanism 181d supports the rotating shaft 181a in the condition where the rotating shaft 181a is rotatable and axially movable. The rotating shaft moving mechanism 181d functions to move the rotating shaft 181a in the axial direction thereof. The rotating shaft 181a is axially moved in the range of a distance d by the rotating shaft moving mechanism 181d. For example, this distance d is set to 6 mm.

Accordingly, by operating the rotating shaft moving mechanism 181d to axially move the rotating shaft 181a, the axial position of the wire R wrapped around the supply roller 181b can be changed, so that the axial position of the wire R passed through the supply roller 181b can be changed. That is, the axial position of the wire R kept in contact with the adjust roller of the adjust roller unit 182 in the axial direction of the adjust roller can be changed in the tension adjusting unit 180 as similarly to the first tension adjusting unit 80. In the operation of the rotating shaft moving mechanism 181d, the rotating shaft 181a may be continuously moved back and forth or may be stepwise moved at given time intervals.

While the multi-wire saw in this preferred embodiment is a multi-wire electrical discharge processing apparatus for performing electrical discharge machining, the multi-wire saw according to the present invention is not limited to such a processing apparatus. For example, the multi-wire saw according to the present invention may be a multi-wire processing apparatus using a wire to which an abrasive is attached, wherein the wire is brought into contact with a workpiece to thereby process the workpiece.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A multi-wire saw comprising:
a wire;
a set of guide rollers having parallel rotation axes, said wire being wrapped around said guide rollers by a plurality of turns;
adjusting means for adjusting tension of said wire wrapped around said guide rollers;
a fixing base for fixing a workpiece to be cut by said wire wrapped around said guide rollers; and
moving means for moving said workpiece fixed to said fixing base toward said wire;
said adjusting means including
an adjust roller around which said wire is wrapped,
a rotational speed control section for controlling the rotational speed of said adjust roller, and
a supply roller around which said wire is wrapped to be supplied to said adjust roller,
said supply roller being provided with wire shifting means for suitably changing the axial position of said wire in the axial direction of said supply roller to thereby prevent the axial position of said wire wrapped around said adjust roller from being fixed.

2. The multi-wire saw according to claim 1, wherein said wire shifting means includes a guide groove formed on said supply roller for guiding said wire;
at least part of said guide groove being inclined with respect to the axial direction of said supply roller.
